(19) United States
(12) Patent Application Publication
(10) Pub. No.: US 2006/0039775 A1
(43) Pub. Date: Feb. 23, 2006

(54) Tapping screw

(76) Inventors: Hiromichi Mizuno, Aichi (JP); Masahiko Hamada, Aichi (JP); Mitsuru Kozawa, Aichi (JP); Kenya Yamada, Aichi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/529,558

(22) PCT Filed: Oct. 2, 2003
(86) PCT No.: PCT/JP03/12706

§ 371 Date: Jun. 17, 2005

(30) Foreign Application Priority Data
Oct. 2, 2002 (JP) 2002-289799

(51) Int. Cl. F16B 25/10

(52) U.S. Cl. 411/387.4

(57) ABSTRACT

The tapping screw has a screw thread having a non-circular shape. Accordingly, when the tapping screw is screwed into the prepared hole formed in the attached member such as a steel plate, etc., the contact area of the screw thread and the circumferential face of the prepared hole of the attached member can be reduced in comparison with the screw thread having a circular outer shape. Accordingly, the screwing torque can be reduced. Further, since the top portion of the screw thread of the square outer shape has a rising shape without being broken, the biting property of the screw thread with respect to the prepared hole formed in the attached member is improved so that a female screw can be precisely threaded on the inner circumferential face of the prepared hole by the screw thread.

### TECHNICAL FIELD

The present invention relates to a tapping screw, and particularly, relates to a tapping screw in which the outer shape of a screw thread seen from the axial direction is a non-circular shape.

### BACKGROUND ART

A conventionally proposed tapping screw is screwed into a prepared hole formed in an attached member so that the tapping screw is fastened to this prepared hole while the tapping screw itself threads the screw. When the screw is threaded in the prepared hole by the tapping screw, the screw threading is advanced by hitting the top portion of the screw thread against the circumference face of the prepared hole. Here, it is publicly known that one portion of a shaft portion is formed in a tapering off shape, or the outer shape of the screw thread seen from its axial direction is a non-circular shape to more efficiently form the screw in the prepared hole. For example, various outer shapes such as a triangular shape (Japanese rice ball shape) having round corners, or an elliptical shape, etc. are proposed as the outer shape of the screw thread seen from its axial direction (e.g., see Patent Document 1).

[Patent Document 1]

JP-A-11-247817 (paragraphs 8 to 9, FIG. 1)

### DISCLOSURE OF THE INVENTION

However, in the above prior art, for example, when the screw thread forming the screw in the prepared hole is broken in fastening the tapping screw to a high tensile steel plate, etc., a problem exists in that the tapping screw cannot be fastened to the partner steel plate. Further, when the screw thread of the non-circular outer shape is not completely pointed in the taper portion, it is difficult to precisely thread the screw in the prepared hole. As a result, a problem exists in that large thrust and screwing torque are required when the portion of the screw thread that is not pointed is screwed and fastened to the prepared hole.

An object of the present invention is to provide a tapping screw in which the screwing torque is reduced and the tapping screw is easily screwed into the prepared hole of the attached member.

In the invention of claim 1, plural notch portions are formed in a specific area of a screw thread continuously formed over a constant diameter portion and a reduced diameter portion. The notch portion has a notch face, a rising wall and a corner portion. The biting property of the screw thread with respect to a prepared hole of an attached member is improved by forming the notch portion. Therefore, a female screw is reliably formed in the prepared hole of the attached member. Further, in the notch portion, the corner portion mainly comes in contact with the circumferential face of the prepared hole. Thus, the contact area of the screw thread bitten into the prepared hole of the attached member is reduced. Therefore, screwing torque of the tapping screw into the prepared hole can be reduced. Accordingly, the screwing torque is reduced and the tapping screw can be easily screwed into the prepared hole of the attached member. Further, the plural notch portions are formed in the circumferential direction of the screw thread. Therefore, the female screw can be precisely formed on the circumferential face of the prepared hole.

In the invention of claim 2, the notch face has a stem face notched and formed on the diametrical inside from the top of the screw thread. Therefore, in the screw thread, the corner portion mainly comes in contact with the circumferential face of the prepared hole in the notch portion. Thus, the contact area of the screw thread bitten into the prepared hole of the attached member is reduced. Accordingly, the screwing torque can be reduced.

In the invention of claim 3, the rising wall is approximately perpendicular to the screw rotating direction. Therefore, the biting property of the screw thread with respect to the prepared hole of the attached member is improved. Thus, the female screw is reliably formed in the prepared hole of the attached member. Accordingly, the screwing torque is reduced and the tapping screw can be easily screwed into the prepared hole of the attached member.

In the invention of claim 4, the corner portion is formed at the diametrical outside end of the rising wall. The corner portion pushes and widens the prepared hole by biting onto the circumferential face of the prepared hole. The screw thread and the notch portion are molded by form rolling. Thus, the shape accuracy of the notch portion is improved and the corner portion is formed in a clear and sharp shape. Therefore, the biting property of the screw thread with respect to the prepared hole of the attached member is improved. Thus, the female screw is reliably formed in the prepared hole of the attached member. Further, in the screw thread, the corner portion mainly comes in contact with the circumferential face of the prepared hole in the notch portion. Therefore, the contact area of the screw thread bitten into the prepared hole of the attached member is reduced. Accordingly, the screwing torque is reduced and the tapping screw can be easily screwed into the prepared hole of the attached member. Further, the screw thread is easily molded by molding the notch portion by form rolling. Accordingly, productivity can be improved.

In the invention of claim 5, the stem portion is formed from a position moved a predetermined angle a from the corner portion on the backward side in the rotating direction to the end portion of the rising wall on its diametrical inside. Therefore, the contact area of the screw thread with respect to the prepared hole of the attached member is reduced. Accordingly, the screwing torque is reduced and the tapping screw can be easily screwed into the prepared hole of the attached member.

In the invention of claim 6, 7 or 8, the screw thread is left in the specific area. Namely, the notch portion is formed by notching one portion of the screw thread. Therefore, in comparison with a case in which the screw thread is deeply notched, the screw thread and the notch portion are easily formed, and the life of a form rolling die is extended. Further, since the notch portion is formed by the form rolling, the corner portion is formed in a clear and sharp shape. As a result, the biting property of the screw thread with respect to the prepared hole of the attached member is improved. Thus, the female screw is reliably formed in the prepared hole of the attached member. Accordingly, the screwing torque is reduced and the tapping screw can be easily screwed into the prepared hole of the attached member. Further, productivity can be improved since the screw thread and the notch portion are easily formed and the life of the form rolling die is extended.

In the invention of claim 9, the outer shape seen from the axial direction of the screw thread is set to be non-circular in the specific area of the screw thread continuously formed over the constant diameter portion and the reduced diameter portion. Further, with respect to the screw thread having the non-circular outer shape, the contact area with the circumferential face of the prepared hole of the attached member is reduced in the specific area. Accordingly, the screwing torque is reduced and the tapping screw can be easily screwed into the prepared hole of the attached member.

In the invention of claim 10, the outer shape of the constant diameter portion seen from the axial direction of the screw thread is set to be non-circular in a predetermined range in the axial direction from the boundary of the constant diameter portion and the reduced diameter portion. Thus, the contact area of the screw thread and the circumferential face of the prepared hole of the attached member is reduced in one portion of the constant diameter portion and the reduced diameter portion. Accordingly, the screwing torque is reduced and the tapping screw can be easily screwed into the prepared hole of the attached member. Further, after the reduced diameter portion is screwed into the prepared hole, the female screw of the same diameter as the constant diameter portion is threaded in the prepared hole in advance before the constant diameter portion is fastened. Accordingly, the constant diameter portion can be easily fastened.

In the invention of claim 11, the shape of the screw thread seen from its axial direction in the specific area is a square shape. Therefore, the top portion of the square screw thread is formed in a rising shape without being broken. Thus, the biting property of the screw thread with respect to the prepared hole of the attached member is improved. Accordingly, the female screw can be reliably formed in the prepared hole.

### BRIEF DESCRIPTION OF THE DRAWINGS

FIG. 1 is a schematic perspective view showing a tapping screw in accordance with a first embodiment mode of the present invention.

FIG. 2 is a plan view showing the tapping screw in accordance with the first embodiment mode of the present invention.

FIG. 3 is a bottom view showing the tapping screw in accordance with the first embodiment mode of the present invention.

FIG. 4 is a cross-sectional view cut along line A-A in FIG. 1.

FIG. 5 is a schematic perspective view showing a tapping screw in accordance with a second embodiment mode of the present invention.

FIG. 6 is a bottom view showing the tapping screw in accordance with the second embodiment mode of the present invention.

FIG. 7 is a bottom view typically showing the outer shape of a screw thread of the tapping screw in accordance with the second embodiment mode of the present invention.

FIG. 8 is a perspective view typically showing one portion of the screw thread of the tapping screw in accordance with the second embodiment mode of the present invention.

FIG. 9 is a typical view of the outer shape of the screw thread of the tapping screw in accordance with the second embodiment mode of the present invention.

### BEST MODE FOR CARRYING OUT THE INVENTION

Plural embodiment modes applying the present invention thereto will next be explained on the basis of the drawings.

### First Embodiment Mode

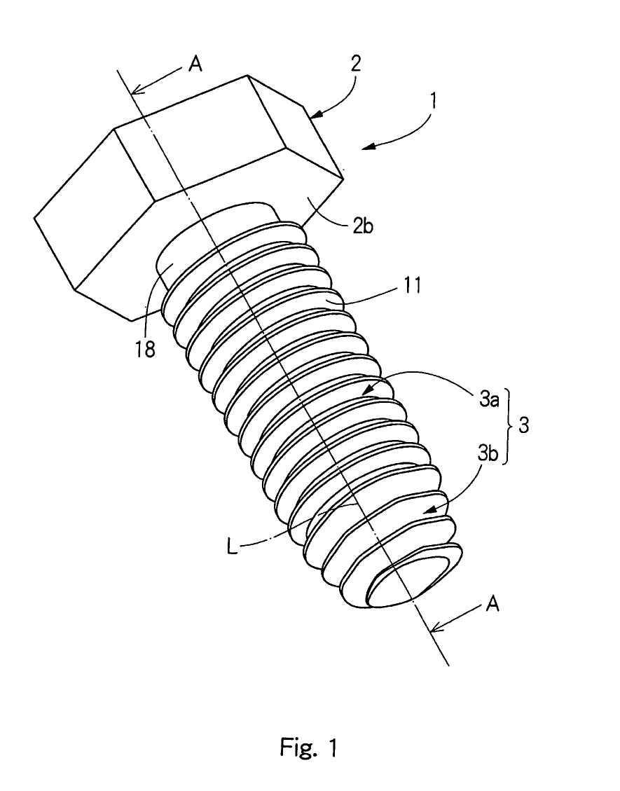

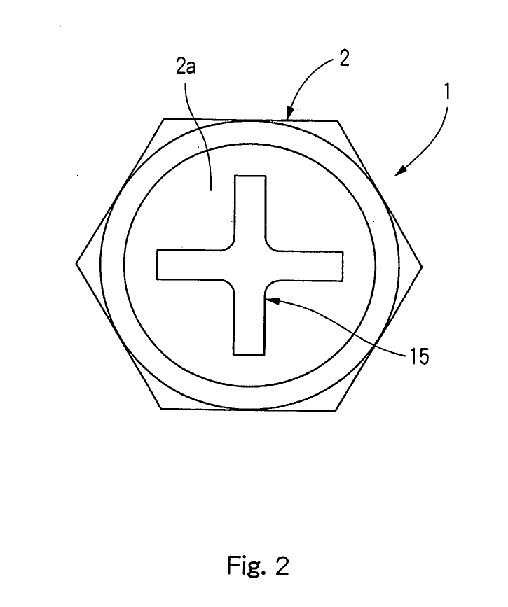

A first embodiment mode of a tapping screw embodying the present invention will be explained with reference to FIGS. 1 to 4. Here, the tapping screw of this embodiment mode is screwed into a prepared hole formed in an unillustrated attached member such as a steel plate, etc. so that the tapping screw is fastened to the attached member while a female screw is formed in that prepared hole. As shown in FIGS. 1 and 2, the tapping screw 1 is constructed by a head portion 2 of a hexagonal columnar shape, and a shaft portion 3 extending downward from the lower side face 2b of this head portion 2. In the tapping screw 1, both the head portion 2 and the shaft portion 3 extend along the common axis L. A cross hole 15 is formed on the upper face 2a of the head portion 2, and the tip of an unillustrated tool for transmitting torque to the tapping screw 1 is fitted into the cross hole 15. The shaft portion 3 is constructed by a constant diameter portion 3a approximately formed in a columnar shape and extending from the head portion 2, and a reduced diameter portion 3b approximately formed in a truncated cone shape and extending from the tip of the constant diameter portion 3a while being gradually reduced in diameter toward the direction opposed to the head portion 2.

The constant diameter portion 3a is formed in the columnar shape having a constant diameter from its base end portion to the tip portion. The reduced diameter portion 3b has a base end portion of the same diameter as the tip portion of the constant diameter portion 3a, and is formed in the truncated cone shape gradually reduced in diameter from the base end portion to the tip portion. The reduced diameter portion 3b is reduced in diameter at a taper angle of about 10° with respect to the constant diameter portion 3a. The taper angle can be arbitrarily changed in accordance with the applied attached member. In the range from the vicinity of the base end of the constant diameter portion 3a to the tip of the reduced diameter portion 3b, a screw thread 11 of a predetermined pitch is continuously formed in its outer circumferential portion. An unthreaded lower neck portion 18 may be also formed in the base end portion of the constant diameter portion 3a. The screw thread 11 is formed in a spiral shape in the outer circumferential portion of the shaft portion 3 except for the lower neck portion 18.

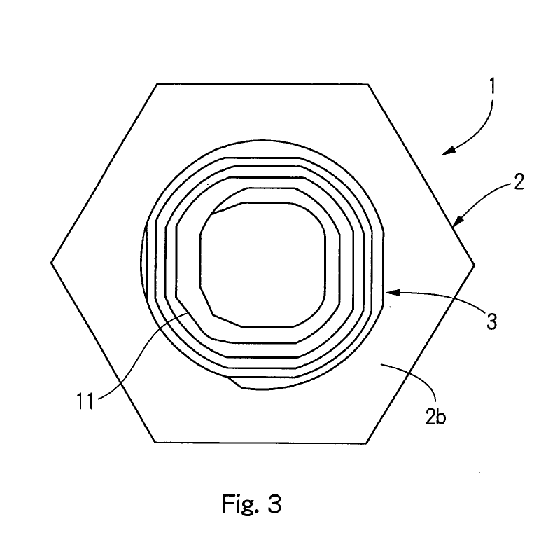

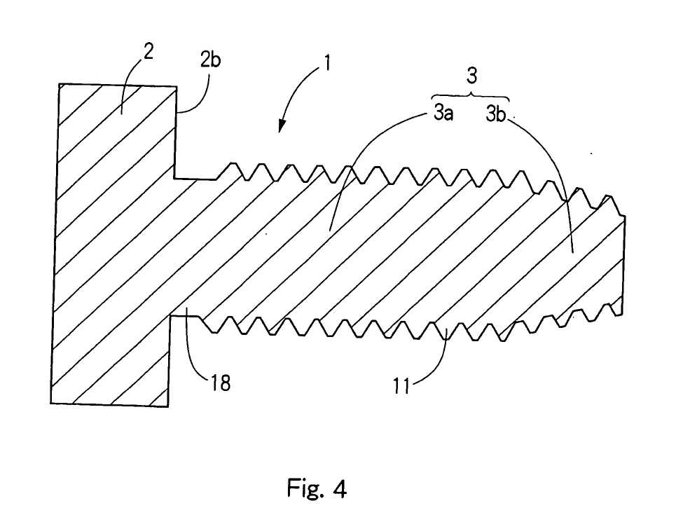

As shown in FIG. 3, when the screw thread 11 is seen from the bottom face side in the axial direction, the outer shape of the screw thread 11 in the tapping screw 1 is approximately a square shape having round corners from the tip portion of the reduced diameter portion 3b through the base end portion in the range from this base end portion to one portion of the tip side of the constant diameter portion 3a. As shown in FIG. 1, the outer shape of the screw thread 11 is a square shape having round corners from the tip of the reduced diameter portion 3b in the head portion 2 direction via the tip portion of the constant diameter portion 3a in a range of two pitches of the screw thread 11 from this tip portion in the base end portion direction. The outer shape of a root portion of the screw is also formed in a square shape having round corners correspondingly to the screw thread 11 although this square shape is unillustrated. Further, as shown in FIG. 4, in a section in which the tapping screw 1 is cut in an arbitrary plane including its axis L, the top portion of the screw thread 11 is formed in a rising shape not broken in all forming ranges thereof including an area in which the outer shape of the screw thread 11 seen from its axial direction is approximately formed in the square shape.

As explained above, the tapping screw 1 of the first embodiment mode has the screw thread 11 having the square outer shape. Therefore, when the tapping screw 1 is screwed into the prepared hole formed in the unillustrated attached member such as a steel plate, etc., the contact area of the screw thread 11 and the circumferential face of the prepared hole of the attached member is reduced in comparison with the conventional tapping screw, i.e., the screw thread having the circular outer shape. Accordingly, the screwing work can be made by screwing torque smaller than that in the conventional case. Further, the top portion of the screw thread 11 having the square outer shape is not broken, but is formed in the rising shape. Therefore, the biting property of the screw thread 11 with respect to the prepared hole formed in the attached member is improved. Accordingly, a female screw can be precisely threaded on the inner circumferential face of the prepared hole by the screw thread 11.

### Second Embodiment Mode

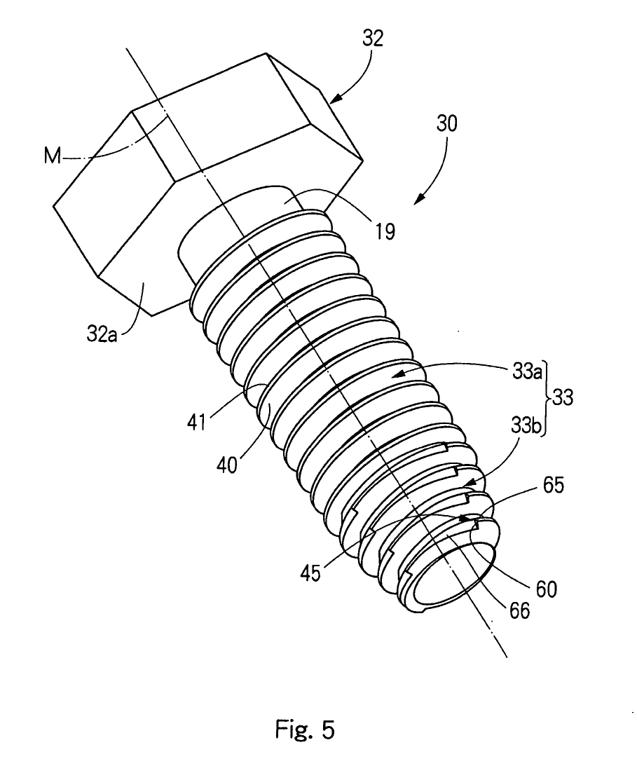

A second embodiment mode of the tapping screw embodying the present invention will next be explained with reference to FIGS. 5 to 9. Here, the tapping screw of this embodiment mode is screwed into a prepared hole formed in an unillustrated attached member such as a steel plate, etc. so that the tapping screw is fastened to the attached member while a female screw is formed in that prepared hole.

First, the entire structure of the tapping screw 30 will be explained with reference to FIG. 5. As shown in FIG. 5, the tapping screw 30 is constructed by a head portion 32 of a hexagonal columnar shape, and a shaft portion 33 extending downward from the lower side face 32a of this head portion 32. In the tapping screw 30, both the head portion 32 and the shaft portion 33 extend along the common axis M. An unillustrated cross hole is formed on the upper face of the head portion 32, and the tip of a tool for transmitting torque to the tapping screw 30 is fitted into this cross hole.

The shaft portion 33 is constructed by a constant diameter portion 33a approximately formed in a columnar shape and extending from the head portion 32, and a reduced diameter portion 33b approximately formed in a truncated cone shape and extending from the tip of the constant diameter portion 33a while being gradually reduced in diameter toward the direction opposed to the head portion 32. The constant diameter portion 33a is formed in the columnar shape having a constant diameter from its base end portion to the tip portion. The reduced diameter portion 33b has a base end portion of the same diameter as the tip portion of the constant diameter portion 33a, and is formed in the truncated cone shape gradually reduced in diameter from the base end portion to the tip portion. The reduced diameter portion 33b is reduced in diameter at a taper angle of about 10° with respect to the constant diameter portion 33a.

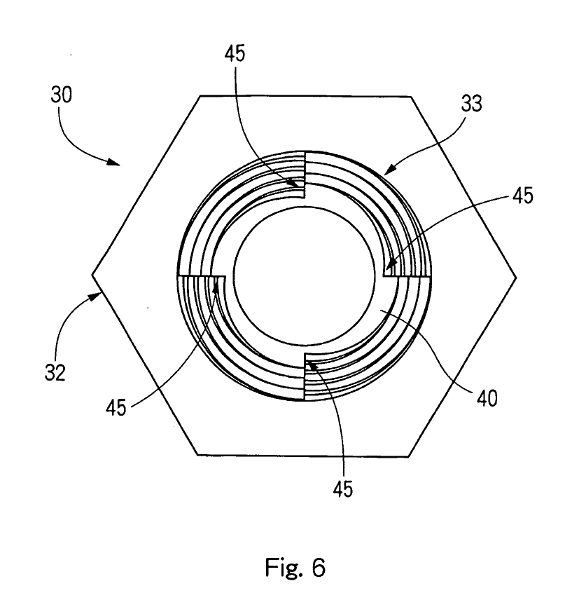

As shown in FIGS. 5 and 6, in the range from the vicinity of the base end portion of the constant diameter portion 33a to the tip portion of the reduced diameter portion 33b, a screw thread 40 of a predetermined pitch is continuously formed in its outer circumferential portion. An unthreaded lower neck portion 19 may be also formed in the base end portion of the constant diameter portion 33a. The screw thread 40 is formed in a spiral shape in the outer circumferential portion of the shaft portion 33 except for the lower neck portion 19.

In the tapping screw 30, a notch portion 45 is formed in the top portion 41 of the screw thread 40 from the tip of the reduced diameter portion 33b in the head portion 32 direction via the tip portion of the constant diameter portion 33a in a range of two pitches of the screw thread 40 from this tip portion to the base end portion side. As shown in FIG. 6, when the screw thread 40 is seen from the bottom face side in the axial direction, plural notch portions 45 are formed in the top portion 41 of the screw thread 40 in approximately equal positions with respect to the circumferential direction of the shaft portion 33. In the case of the second embodiment mode, the notch portions 45 are equally formed in four places in the circumferential direction. All the notch portions 45 are formed in the same shape. The notch portions 45 are formed every four notch portions with respect to the screw thread 40 of one pitch so as to be overlapped with each other when they are seen from the bottom face. Namely, in the top portion 41 of the screw thread 40 of one pitch, the four notch portions 45 are formed one by one at the interval of a rotating angle of 90° in the circumferential direction of the shaft portion 33 when they are seen from the bottom face.

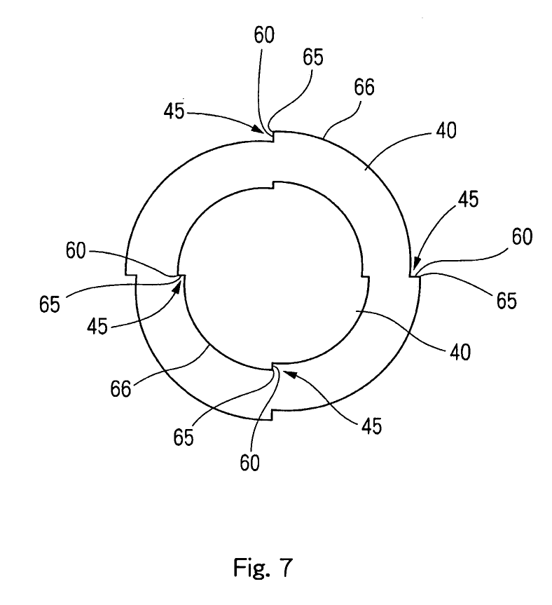

Next, the outer shape of the screw thread 40 forming the notch portion 45 in the top portion will be explained in detail with reference to FIG. 7. Here, FIG. 7 is a bottom view typically showing the outer shape of the screw thread 40. As shown in FIG. 7, when the screw thread 40 formed in the shaft portion 33 is seen from the bottom face side in the axial direction, the round circle of the screw thread 40 is divided into four equal fan-shaped areas, and the circumferential edge portion of each area is formed in a shape notched in a semi-crescent shape by the notch portion 45. Thus, the screw thread 40 is approximately formed in a windmill type shape as a whole.

The notch portion 45 has a rising wall 60, a corner portion 65 and a notch face 66. The rising wall 60 is approximately perpendicular to the rotating direction of the tapping screw 30. The rising wall 60 is connected to each of the adjacent notch faces 66 inside and outside the tapping screw 30 in its diametrical direction. Namely, the rising wall 60 connects two notch faces 66 adjacent to each other in the circumferential direction to each other in the circumferential direction of the tapping screw 30. Thus, the end portion of the notch face 66 on the forward side in the rotating direction of the tapping screw 30 is connected to the end portion of the rising wall 60 on its outside in the diametrical direction, and the end portion of the notch face 66 on the backward side is connected to the end portion of the adjacent rising wall 60 on its inside in the diametrical direction.

The corner portion 65 is formed in the connecting portion of the notch face 66 and the end portion of the rising wall 60 on the outside of the tapping screw 30 in the diametrical direction. The corner portion 65 comes in contact with the prepared hole formed in the attached member as the tapping screw 30 is rotated. Thus, the corner portion 65 pushes and widens the inner wall of the prepared hole and forms a female screw.

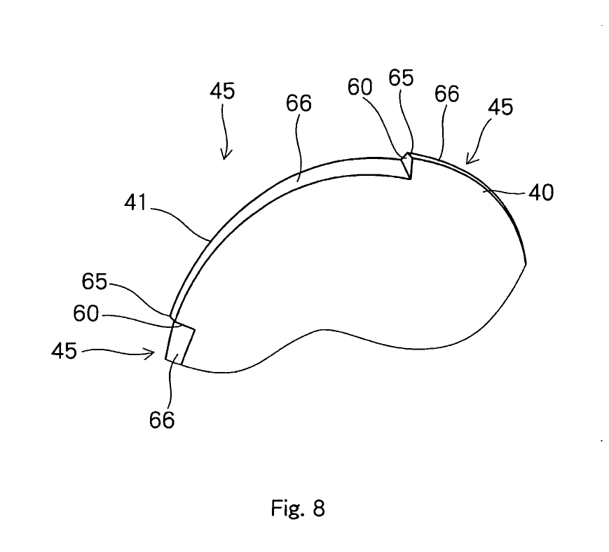

The notch face 66 connects the adjacent rising walls 60 to each other as mentioned above. The notch face 66 is an end face of the screw thread 40 on its outside in the diametrical direction formed in the tapping screw 30. Namely, in the tapping screw 30, the screw thread 40 is left even in the forming area of the notch portion 45. In other words, the notch portion 45 is in a shaving state of the diametrical outside of the screw thread 40, i.e., its top. One end portion of the notch face 66 is connected to the root of the rising wall 60 in the circumferential direction of the tapping screw 30, and the other end portion is connected to the tip of the rising wall 60, i.e., the corner portion 65. On the notch face 66, the axial length of the tapping screw 30 is gradually reduced from one end portion side connected to the root of the rising wall 60 to the other end portion side connected to the corner portion 65 in the circumferential direction of the tapping screw 30 as shown in FIG. 8. This is because the axial length of the screw thread 40 is reduced from the inside to the outside in the diametrical direction. Namely, this is because the axial length of the screw thread 40 is long inside the rising wall 60 in the diametrical direction, but is short outside the rising wall 60 in the diametrical direction.

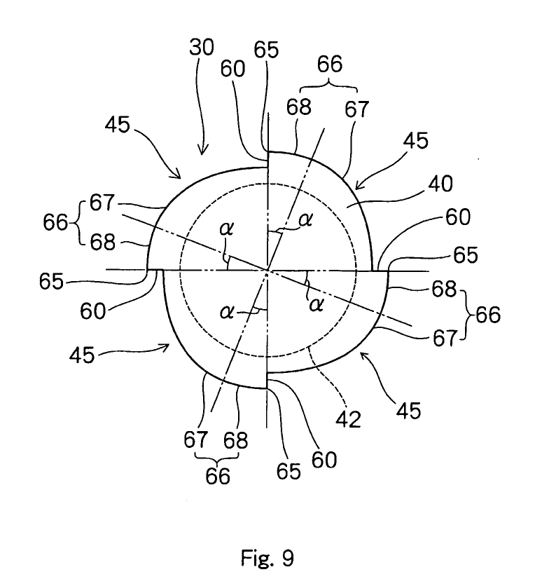

As shown in FIG. 9, the notch face 66 has a stem face 67 in one portion of the tapping screw 30 in its circumferential direction. FIG. 9 is a typical view showing a sectional shape of the tapping screw 30 and showing one pitch of the screw thread 40.

The notch face 66 has a circumferential face 68 having a constant outside diameter in the range of a predetermined central angle a from the corner portion 65 in the circumferential direction of the tapping screw 30. In contrast, the outside diameter of the notch face 66 is gradually reduced and the notch face 66 enters the central side from the end portion of the circumferential face 68 on its side opposed to the corner portion to the root of the rising wall 60. A portion changed in the outside diameter among this notch face 66 is the stem face 67. Namely, one end portion of the stem face 67 in the circumferential direction of the tapping screw 30 is connected to the end portion of the circumferential face 68 on its side opposed to the corner portion, and the other end portion is connected to the end portion of the rising wall 60 on its diametrical inside. In the case of this embodiment mode, the central angle α is about 20°. In addition, for example the central angle α can be arbitrarily set in accordance with the material of the attached member applying the tapping screw 30 thereto, the inside diameter of the prepared hole, etc.

As mentioned above, in the tapping screw 30, the screw thread 4 0 is left even in the forming area of the notch portion 45. Namely, as shown in FIG. 8, the screw thread 40 has a predetermined height from the screw bottom portion 42 to the root of the rising wall 60 even in the connecting portion of the notch face 66 lowest in the screw thread 40 and the root of the rising wall 60.

As explained above, in the tapping screw 30 of the second embodiment mode, the notch portions 45 equally located in the circumferential direction of the shaft portion 33 are formed in the screw thread 40 surrounding the shaft portion 33 in a spiral shape in a predetermined range along the axial direction from the tip of the shaft portion 33. In the notch portion 45, the corner portion 65 located in a circumferential edge portion is located on the diametrical outermost side of the screw thread 40, and is molded together with the screw thread 40 by form rolling. Thus, the corner portion 65 is formed in a clear and sharp shape. Accordingly, when the tapping screw 30 is screwed into the prepared hole formed in the attached member, the corner portion 65 can precisely thread the inner wall of the prepared hole. Further, the rising wall 60 of the notch portion 45 is perpendicular to the rotating direction of the tapping screw 30, and its surface is in a state in which this surface is always directed forward in the rotating direction. Thus, as the tapping screw 30 is rotated, one portion of the rising wall 60 as well as the corner portion 65 comes in contact with the inner wall of the prepared hole. Accordingly, the biting property of the screw thread 40 into the prepared hole is improved and the female screw can be more efficiently formed in the prepared hole. Further, the female screw can be precisely formed in the prepared hole since the plural notch portions 45 are formed so as to be equally located in the circumferential direction of the screw thread 40.

The present invention is not limited to the above embodiment modes, but can be variously modified. For example, in the above first embodiment mode, the outer shape viewed from the axial direction of the screw thread is set to the square shape. However, the outer shape of the screw thread is not limited to the square shape, but may be also set to a polygonal shape of a triangular shape or a pentagonal shape or more. Further, in this embodiment mode, the outer shape of the screw thread from the reduced diameter portion 3b to one portion of the constant diameter portion 3a is set to the square shape. However, no range for setting the outer shape of the screw thread to the square shape is limited to the range shown in this embodiment mode. Similarly, in the second embodiment mode, the notch portion 45 is formed in the screw thread from the reduced diameter portion 33b to one portion of the constant diameter portion 33a. However, no range for forming the notch portion 45 is limited to the range shown in this embodiment mode. Further, in the above second embodiment mode, the notch portions 45 are formed every four notch portions so as to be overlapped with each other when they are seen from the bottom face with respect to the screw thread 40 of one pitch. However, the number of notch portions 45 is not limited to four, but can be suitably changed. In addition, the shape of the notch is not limited to that in this embodiment mode, but may be also set to a shape in which the screw is precisely formed in the prepared hole of the attached member.

1. A tapping screw comprising a head portion and a shaft portion extending from said head portion, and forming a female screw in a prepared hole formed in an attached member while the tip portion of said shaft portion is screwed into said prepared hole;
wherein said shaft portion has:
a columnar constant diameter portion extending from said head portion and having a constant diameter;
a reduced diameter portion of a truncated cone shape extending from the tip of said constant diameter portion in the direction opposed to said head portion, and reduced in diameter as it is advanced in the direction opposed to said head portion; and
a spiral screw thread continuously formed over the outer circumferential face of said constant diameter portion and the outer circumferential face of said reduced diameter portion;
plural notch portions are formed in a specific area of said screw thread in the circumferential direction of said shaft portion; and
said notch portion has a notch face, a rising wall and a corner portion.

2. The tapping screw according to claim 1, wherein said notch face has a stem face notched and formed on the diametrical inside from the top of said screw thread.

3. The tapping screw according to claim 1, wherein said rising wall is approximately perpendicular to the screw rotating direction.

4. The tapping screw according to claim 1, wherein said corner portion is formed at a diametrical outside end of said rising wall.

5. The tapping screw according to claim 2, wherein said stem face has one end connected in a position moved a predetermined angle a from said corner portion to the backward side in the rotating direction, and also has a surface moved in the diametrical inside direction as it proceeds to the backward side in the rotating direction, and further has the other end connected to the end portion of said rising wall on its diametrical inside.

6. The tapping screw according to claim 1, wherein said screw thread is left in said specific area.

7. The tapping screw according to claim 1, wherein the top of said screw thread is shaved in said specific area.

8. The tapping screw according to claim 2, wherein the screw thread low in height on said stem face is left in said specific area.

9. A tapping screw comprising a head portion and a shaft portion extending from said head portion, and forming a female screw in a prepared hole formed in an attached member while the tip portion of said shaft portion is screwed into said prepared hole;
wherein said shaft portion has:
a columnar constant diameter portion extending from said head portion and having a constant diameter;
a reduced diameter portion of a truncated cone shape extending from the tip of said constant diameter portion in the direction opposed to said head portion, and reduced in diameter as it is advanced in the direction opposed to said head portion; and
a spiral screw thread continuously formed over the outer circumferential face of said constant diameter portion and the outer circumferential face of said reduced diameter portion; and
the outer shape seen from the axial direction of said screw thread is set to be non-circular in the specific area of said screw thread.

10. The tapping screw according to claim 9, wherein the outer shape of said constant diameter portion seen from the axial direction of said screw thread is set to be non-circular over a predetermined range in the axial direction from the boundary of said constant diameter portion and said reduced diameter portion.

11. The tapping screw according to claim 9, wherein the shape of said screw thread seen from its axial direction is a square shape, and the screw thread formed in the outer circumferential portion of said shaft portion and including the screw thread of the square outer shape seen from the axial direction rises in all forming areas without breaking its top portion.
